(19) United States
(12) Patent Application Publication
(10) Pub. No.: US 2008/0094754 A1
(43) Pub. Date: Apr. 24, 2008

(54) Method of manufacturing a head assembly

(75) Inventors: Atsuo Makino, Kawasaki (JP); Kenichi Makino, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/785,636

(22) Filed: Apr. 19, 2007

(30) Foreign Application Priority Data
Oct. 18, 2006 (JP) 2006-283693

(51) Int. Cl. G11B 21/20

(52) U.S. Cl. 360/234.6

(57) ABSTRACT

A method of manufacturing a head assembly improves the attachment position precision of a gimbal and a slider with a head, increases the efficiency of the attachment process, and can be carried out at low cost using small-scale equipment. The method of manufacturing includes an adhesive applying step of applying adhesive onto a gimbal; a slider setting step of setting a slider on the gimbal so that part of the adhesive sticks out from a side surface of the slider; a first hardening step of hardening the part of the adhesive that sticks out from a side surface of the slider; and a second hardening step of hardening a part of the adhesive between the gimbal and the slider.

### BACKGROUND OF THE INVENTION

1. Field of the Invention

The present invention relates to a method of manufacturing a head assembly, and in more detail to a method of manufacturing a head assembly where a head slider is joined to a gimbal.

2. Related Art

A head assembly installed in a hard disk apparatus is assembled by mounting a head slider to a gimbal formed on a suspension. The head assembly is assembled by applying adhesive onto the upper surface of the gimbal, positioning and setting the head slider (hereinafter referred to simply as the “slider”) on the adhesive, and then hardening the adhesive between the slider and the gimbal.

Patent Document 1 discloses a technology that assembles a core slider and a gimbal by attaching the core slider and the gimbal using a thermosetting adhesive and hardening the adhesive by irradiating the adhesive part with an energy beam.

Patent Document 2 discloses a technology where a low-elasticity epoxy adhesive is interposed between a slider and a suspension and the adhesive is irradiated with laser light to partially harden part of the adhesive.

### Patent Document 1

Japanese Laid-Open Patent Publication No. H05-290490

### Patent Document 2

Japanese Patent No. 3,598,076

### SUMMARY OF THE INVENTION

In Patent Document 1, by gradually increasing the output of the energy beam, sudden fluidization of the adhesive is prevented and the attachment precision of the core slider on the gimbal can be improved. However, since more time is required to harden the adhesive, there is the problem of poor efficiency during the process that joins the core slider and the gimbal.

In Patent Document 2, since part of the adhesive is hardened by irradiation with laser light during the process that attaches the slider and the suspension, it is possible to greatly improve the attachment precision of the slider and the suspension. However, since a constant-temperature oven is required, there is an increase in the scale of the equipment used to assemble a head assembly. In addition, since a heater is used, there is the further problem of an increased cost for the process that assembles the slider and suspension.

It is an object of the present invention to provide a method of manufacturing a head assembly that can improve the attachment positioning precision of a gimbal and a slider equipped with a head, can improve the efficiency of the attachment process, and can be carried out with at low cost using small-scale equipment.

A method of manufacturing a head assembly according to the present invention includes: an adhesive applying step of applying adhesive onto a gimbal; a slider setting step of setting a slider on the gimbal so that part of the adhesive sticks out from a side surface of the slider; a first hardening step of hardening the part of the adhesive that sticks out from the side surface of the slider; and a second hardening step of hardening a part of the adhesive between the gimbal and the slider.

A thermosetting UV adhesive may be used as the adhesive, in the first hardening step, the adhesive may be irradiated with UV rays, and in the second hardening step, a region where the adhesive is applied may be irradiated with laser light. By doing so, it is possible to permanently attach the slider and the gimbal in the second hardening step after first provisionally attaching the slider and the gimbal in the first hardening step. This is advantageous in preventing displacement in the relative positions of the slider and the gimbal during the process that hardens the adhesive.

In the first hardening step, the adhesive may be irradiated with UV rays from diagonally above the side surface of the slider. By doing so, it is possible to have the adhesive reliably irradiated with the UV rays, and therefore the adhesive can be provisionally hardened reliably.

In the second hardening step, a rear surface side of the gimbal may be irradiated with laser light. By doing so, it is possible to minimize the effect of heat on the gimbal, and therefore deformation of the gimbal after the adhesive hardening process can be suppressed.

In the second hardening step, the laser light may be emitted with one out of a converging lens and a beam-splitting lens set between the gimbal and a laser light emitting unit.

Alternatively, in the second hardening step, a shield plate may be disposed between the gimbal and a laser light emitting unit and the gimbal may be irradiated with laser light that has passed through the shield plate.

By doing so, it is possible to suitably carry out irradiation with laser light in accordance with the shape of the gimbal on which the slider is mounted, making the assembly process more efficient.

In the second hardening step, output of the laser light may be controlled using a laser light output control means so that the thermosetting UV adhesive is rapidly heated to a hardening temperature and thereafter maintained at the hardening temperature for a predetermined time. By doing so, it is possible to greatly reduce the time spent in a temperature range where fluidization occurs for the adhesive, thereby making it possible to prevent displacement in the attachment position of the slider on the gimbal and to attach the slider to the gimbal with high precision.

By using the method of manufacturing a head assembly according to the present invention, a slider equipped with a head can be provisionally fixed to a gimbal immediately after the slider has been positioned on the gimbal, and therefore even if the head assembly is handled during manufacturing, the attachment position of the slider on the gimbal will not become displaced from the original position.

Also, since it is possible to completely harden the adhesive without using a heating oven, the scale of the apparatus for assembling a head assembly can be reduced, thereby making it possible to greatly reduce the running cost.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIG. 1 is a view showing the construction of an apparatus for assembling a head assembly according to an embodiment of the present invention;

FIG. 2 is an enlarged view of part A in FIG. 1;

FIG. 3 is an enlarged view of part B in FIG. 1;

FIG. 4 is a view when looking in the direction of the arrow C in FIG. 3;

FIG. 5 is a graph showing the relationship between the output of laser light during irradiation and the time axis;

FIG. 6 is a diagram showing how the gimbal is irradiated with laser light that has been transmitted by a beam-splitting lens; and

FIG. 7 is a diagram showing how the gimbal is irradiated with laser light using a shield plate.

### DESCRIPTION OF THE PREFERRED EMBODIMENTS

### First Embodiment

Preferred embodiments of a method of manufacturing a head assembly will now be described with reference to the attached drawings. The expression “head assembly” in the present embodiment refers to a so-called HGA (Head Gimbal Assembly).

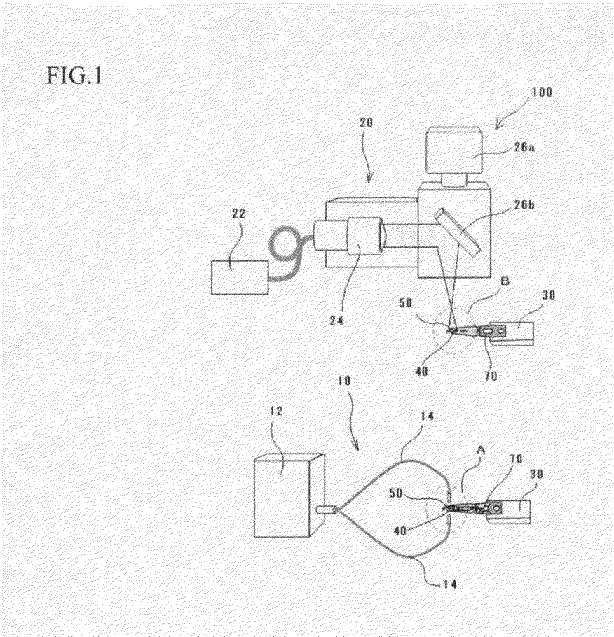

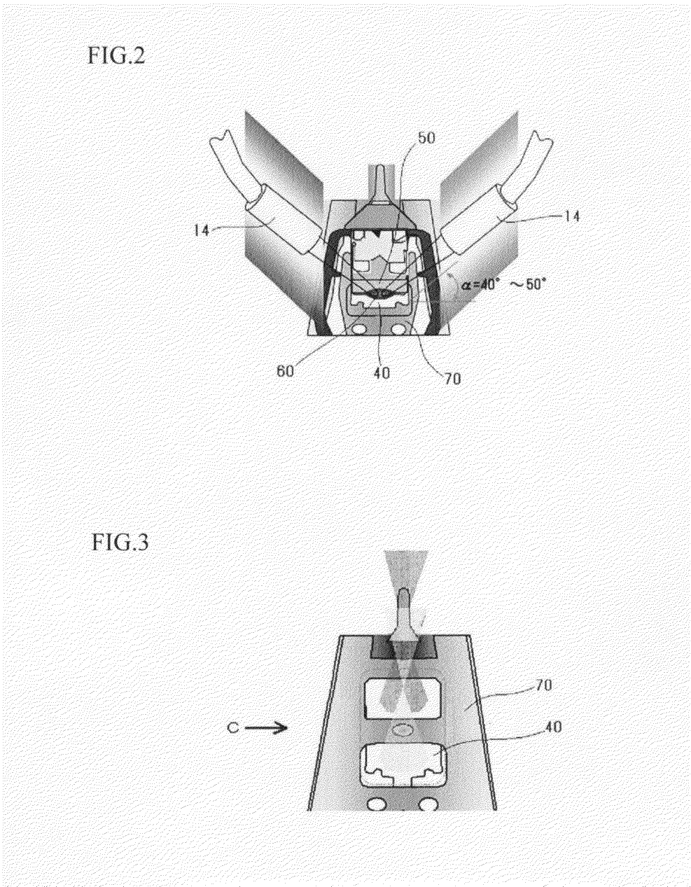

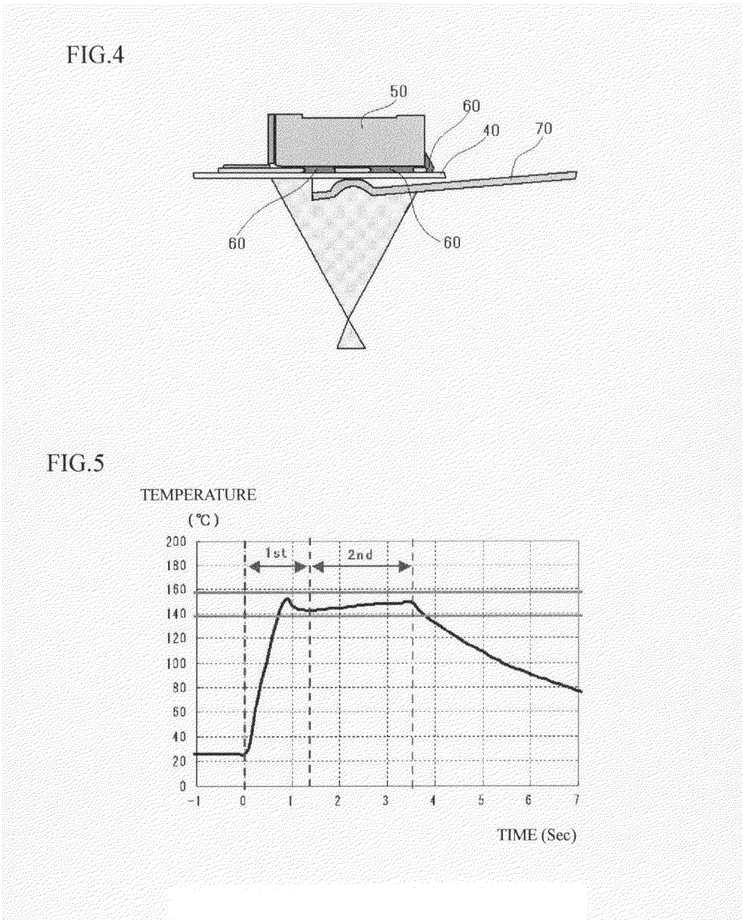

FIG. 1 is a view showing the construction of an apparatus for assembling a head assembly according to the present embodiment. FIG. 2 is an enlarged view of part A in FIG. 1. FIG. 3 is an enlarged view of part B in FIG. 1. FIG. 4 is a view when looking in the direction of the arrow C in FIG. 3. FIG. 5 is a graph showing the relationship between the output of laser light during irradiation and the time axis.

The apparatus 100 for assembling a head assembly in the present embodiment includes a UV-ray irradiating unit 10, a laser light irradiating unit 20, and a conveying unit 30.

The UV-ray irradiating unit 10 hardens one part of adhesive (thermosetting UV adhesive) 60 interposed between a gimbal 40 and a slider 50 equipped with a head to provisionally fix the slider 50 to the gimbal 40. In the present embodiment, part of the adhesive 60 interposed between the gimbal 40 and the slider 50 sticks out from the side of the slider 50, which makes it possible for only part of the adhesive 60 to be irradiated with UV rays. It is therefore possible to harden only part of the adhesive 60.

The UV-ray irradiating unit 10 includes a UV lamp 12 and guides 14. The guides 14 guide UV rays emitted by the UV lamp 12 to a desired position on the gimbal 40 and the slider 50. Optical cables or the like can be favorably used as the guides 14.

As shown in FIG. 2, the guides 14 transmit UV rays onto the gimbal 40 and the slider 50 from diagonally above the mounting surface of the gimbal 40. In the present embodiment, the two guides 14 are disposed on both sides of the sticking-out part of the adhesive 60 so that the angle a between the optical axes of the UV rays used to irradiate the gimbal 40 and the slider 50 and the mounting surface of the gimbal 40 and the slider 50 (the air bearing surface of the slider 50) is α=40 to 50° (preferably α=45°). The guides 14 are also disposed so that the end positions of the guides 14 are located around 1 mm from the surface of the adhesive 60.

The laser light irradiating unit 20 includes a semiconductor laser 22 that emits laser light, a fiber collimator 24 that is a converging lens, a laser irradiating position guiding means 26 that has a predetermined part of the gimbal 40 irradiated with the laser light transmitted from the fiber collimator 24, and a laser light output control unit 28 that controls the output of the laser light. The laser irradiating position guiding means 26 has a part of a lower surface (rear surface) side of the gimbal 40 that corresponds to the planar surface of the adhesive 60 applied to the gimbal 40 irradiated with laser light. When doing so, although the lower surface of the gimbal 40 is irradiated with laser light and the adhesive 60 is not directly irradiated with the laser light, the gimbal 40 that is formed of stainless steel will heat up due to the irradiation with laser light. This heat is transmitted to the adhesive 60 by conduction, thereby making it possible to harden the adhesive 60.

The laser irradiating position guiding means 26 includes a CCD camera 26a that picks up an image of the lower surface side of the gimbal 40. The laser irradiating position guiding means 26 calculates coordinates of a position to be irradiated with laser light based on image information picked up by the CCD camera 26a, and controls the setting state (i.e., the setting angle) of a reflector 26b that reflects the laser light transmitted from the fiber collimator 24 to the calculated coordinate position.

Based on the image information of the lower surface side of the gimbal 40 picked up by the CCD camera 26a and information on the position (i.e., coordinate position) of the adhesive 60 applied on the gimbal 40 that is stored in advance in a storage means incorporated in the laser irradiating position guiding means 26, the laser irradiating position guiding means 26 controls the setting angle of the reflector 26b with respect to the fiber collimator 24.

The laser light output control unit 28 controls the voltage supplied to the semiconductor laser 22 so that the output of the laser light used to irradiate the lower surface side of the gimbal 40 is as shown in FIG. 5. More specifically, the laser light output control unit 28 controls emission of “first laser light”, which raises the adhesive 60 to the hardening temperature of 150° C. of the adhesive 60 within a short time (around 0.8 seconds) of the start of irradiation, and “second laser light”; which keeps the temperature of the adhesive 60 at around 150° C., for a predetermined time (around 2.7 seconds in the present embodiment). Since adjusting the output of laser light in this way makes it possible to suppress the time spent in the temperature range where fluidization occurs for the adhesive 60, it is possible to suppress displacement in the set position of the slider 50 on the gimbal 40.

The conveying unit 30 is provided so as to be capable of moving inside the apparatus 100 for assembling a head assembly. When a suspension 70 on which the gimbal 40 has been attached is supplied from outside the apparatus 100 by a supplying means, not shown, the conveying unit 30 conveys the suspension 70 to the UV-ray irradiating unit 10 and the laser light irradiating unit 20 and, after the respective processes have been completed, conveys the head assembly out of the apparatus 100.

Next, the procedure for assembling a magnetic head using the apparatus 100 for assembling a head assembly according to the present embodiment will be described.

First, the gimbal 40 that has been combined with the suspension 70 is set in the UV-ray irradiating unit 10 from the supplying means, not shown, outside the apparatus 100. At this stage, the gimbal 40 is positioned and set on the suspension 70.

An adhesive applying means (not shown) applies the adhesive 60 onto the gimbal 40 set in the UV-ray irradiating unit 10. The adhesive applying means applies the adhesive 60 so that part of the adhesive 60 will stick out from a side surface part of the slider 50 to be set on the gimbal 40. After this, a head supplying means, not shown, sets the slider 50 on the gimbal 40. The head supplying means has a positioning function for setting the slider 50 at a predetermined position on the gimbal 40.

After the slider 50 has been set on the gimbal 40, a slider supplying means presses the slider 50 and a support member supports the gimbal 40 (neither the slider supplying means nor the support member is shown), thereby pressing the adhesive 60 via the slider 50 and the gimbal 40. In this state, the UV-ray irradiating unit 10 has the part of the adhesive 60 that sticks out irradiated with UV rays to harden part of the adhesive 60. After irradiation with UV rays has been completed and the sticking out part of the adhesive 60 has been hardened, the conveying unit 30 conveys the suspension 70, to which the slider 50 has been attached, to the laser light irradiating unit 20.

The suspension 70 attached to the slider 50 conveyed to the laser light irradiating unit 20 is flipped by the conveying unit 30 so that the slider 50 is on the lower side, as shown in FIGS. 1 and 4.

The CCD camera 26a of the laser light irradiating unit 20 picks up an image of the gimbal 40 that has been flipped. Based on the picked-up image data of the gimbal 40, the laser irradiating position guiding means 26 calculates the coordinates of the application position of the adhesive 60 for the gimbal 40 as presently positioned. The laser irradiating position guiding means 26 calculates the displacement between (1) coordinates of an application position of the adhesive 60 stored in advance in the storage means provided inside the laser irradiating position guiding means 26 and (2) coordinates of the application position of the adhesive 60 as presently positioned, and adjusts the disposed angle of the reflector 26b.

Next, the laser light irradiating unit 20 has the coordinates of the applied position of the adhesive 60 on the gimbal 40 as presently positioned irradiated with laser light. The laser light used to irradiate the application position of the adhesive 60 on the gimbal 40 should preferably be laser light that is more blurred than sharp laser light. By blurring the laser light, localized increases in the temperature of the adhesive 60 applied onto the gimbal 40 are suppressed, and therefore it is possible to uniformly harden the adhesive 60.

In the laser light irradiating unit 20, the output of the laser light used to irradiate the gimbal 40 is controlled by the laser light output control unit 28. More specifically, the laser light output control unit 28 has the gimbal 40 irradiated with first laser light that causes the temperature to reach 150° C., i.e., the hardening temperature of the adhesive 60, within a short time (around 0.8 seconds) from the start of irradiation. After this, the laser light output control unit 28 has the gimbal 40 irradiated with the second laser light that keeps the temperature of the adhesive 60 at around 150° C. for a predetermined time (around 2.7 seconds in the present embodiment).

As described above, after the lower surface side of the gimbal 40 has been irradiated with laser light, the conveying unit 30 conveys the suspension 70 in a state where the slider 50 is completely fixed to the gimbal 40 out of the apparatus 100, thereby passing the suspension 70 over to the next process.

### Second Embodiment

In the first embodiment described above, an apparatus 100 for assembling a head assembly where the laser light irradiating unit 20 includes a fiber collimator 24 as a converging lens and a method of assembling a head assembly using such apparatus have been described. However, with the construction described above, when the adhesive 60 is applied at a plurality of positions on the gimbal 40, after the adhesive 60 at one position has been irradiated with laser light, the setting angle of the reflector 26b needs to be changed so that the adhesive 60 at another position can be irradiated with laser light. Accordingly, the time taken by the thermosetting process (the second hardening process) for the adhesive 60 increases in proportion to the number of positions where the adhesive 60 is applied.

In this case, a beam-splitting lens may be disposed in the laser light irradiating unit 20 in addition to the converging lens. By doing so, the control unit (not shown) of the laser light irradiating unit 20 or the user can select either the converging lens (the fiber collimator 24) or the beam-splitting lens in accordance with the application conditions of the adhesive, such as the number of positions at which the adhesive 60 is applied on the gimbal 40. That is, even if the adhesive 60 is applied onto the gimbal 40 at a plurality of positions, the laser light irradiating unit 20 can complete the main adhesive hardening process (the second hardening process) by emitting laser light onto the gimbal 40 in a single operation.

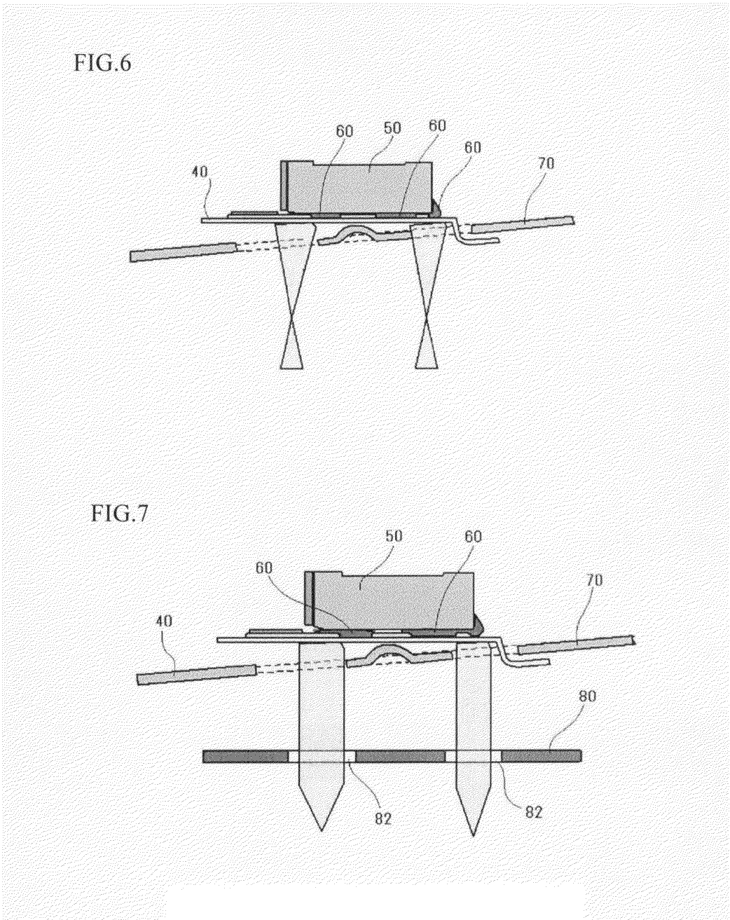

In the present embodiment, like the embodiment described above, the gimbal 40 should preferably be irradiated with laser light that is more blurred than sharp laser light. FIG. 6 is a diagram showing how laser light that is transmitted by the beam-splitting lens is emitted onto the gimbal 40.

### Third Embodiment

In the embodiments described above, an optical lens (a converging lens, such as a fiber collimator, or a beam-splitting lens) is disposed between the semiconductor laser 22 and the reflector 26b to irradiate predetermined positions on the gimbal 40 with laser light. However, it is possible to use a construction where the laser light emitted from the semiconductor laser 22 is transmitted onto predetermined positions on the gimbal 40 by passing the laser light through a shield plate 80 in which slits 82 are formed after the laser light has been reflected by the reflector 26b. FIG. 7 is a diagram showing a state where the gimbal is irradiated with laser light that has passed through a shield plate.

By using the shield plate 80 with the slits 82 in place of an optical lens such as a converging lens or a beam-splitting lens, it is possible to prevent unintentional heating of the gimbal 40 at positions aside from the application positions of the adhesive 60, and therefore deformation of the gimbal 40 due to heat can be minimized. Since the shield plate 80 can be acquired at low cost compared to an optical lens, it is possible to reduce the manufacturing cost of the apparatus 100 for assembling a head assembly. It is also favorable to not use an optical lens since this makes it possible to reduce the handling and maintenance of the laser light irradiating unit 20.

What is claimed is:

1. A method of manufacturing a head assembly, comprising:
an adhesive applying step of applying adhesive onto a gimbal;
a slider setting step of setting a slider on the gimbal so that part of the adhesive sticks out from a side surface of the slider;
a first hardening step of hardening the part of the adhesive that sticks out from the side surface of the slider; and
a second hardening step of hardening a part of the adhesive between the gimbal and the slider.

2. A method of manufacturing a head assembly according to claim 1,
wherein a thermosetting UV adhesive is used as the adhesive,
in the first hardening step, the adhesive is irradiated with UV rays, and
in the second hardening step, a region where the adhesive is applied is irradiated with laser light.

3. A method of manufacturing a head assembly according to claim 2,
wherein in the first hardening step, the adhesive is irradiated with UV rays from diagonally above the side surface of the slider.

4. A method of manufacturing a head assembly according to claim 2,
wherein in the second hardening step, a rear surface side of the gimbal is irradiated with laser light.

5. A method of manufacturing a head assembly according to claim 3,
wherein in the second hardening step, a rear surface side of the gimbal is irradiated with laser light.

6. A method of manufacturing a head assembly according to claim 2,
wherein in the second hardening step, the laser light is emitted with one out of a converging lens and a beam-splitting lens set between the gimbal and a laser light emitting unit.

7. A method of manufacturing a head assembly according to claim 3,
wherein in the second hardening step, the laser light is emitted with one out of a converging lens and a beam-splitting lens set between the gimbal and a laser light emitting unit.

8. A method of manufacturing a head assembly according to claim 4,
wherein in the second hardening step, the laser light is emitted with one out of a converging lens and a beam-splitting lens set between the gimbal and a laser light emitting unit.

9. A method of manufacturing a head assembly according to claim 2,
wherein in the second hardening step, a shield plate is disposed between the gimbal and a laser light emitting unit and the gimbal is irradiated with laser light that has passed through the shield plate.

10. A method of manufacturing a head assembly according to claim 3,
wherein in the second hardening step, a shield plate is disposed between the gimbal and a laser light emitting unit and the gimbal is irradiated with laser light that has passed through the shield plate.

11. A method of manufacturing a head assembly according to claim 4,
wherein in the second hardening step, a shield plate is disposed between the gimbal and a laser light emitting unit and the gimbal is irradiated with laser light that has passed through the shield plate.

12. A method of manufacturing a head assembly according to claim 2,
wherein in the second hardening step, output of the laser light is controlled using a laser light output control means so that the thermosetting UV adhesive is rapidly heated to a hardening temperature and thereafter maintained at the hardening temperature for a predetermined time.

13. A method of manufacturing a head assembly according to claim 3,
wherein in the second hardening step, output of the laser light is controlled using a laser light output control means so that the thermosetting UV adhesive is rapidly heated to a hardening temperature and thereafter maintained at the hardening temperature for a predetermined time.

14. A method of manufacturing a head assembly according to claim 4,
wherein in the second hardening step, output of the laser light is controlled using a laser light output control means so that the thermosetting UV adhesive is rapidly heated to a hardening temperature and thereafter maintained at the hardening temperature for a predetermined time.
